(19) United States
(12) Patent Application Publication
(10) Pub. No.: US 2026/0332063 A1
(43) Pub. Date: Oct. 22, 2026

(54) POWER CONVERSION DEVICE

(71) Applicant: HITACHI ASTEMO, LTD., Hitachinaka-shi, Ibaraki (JP)

(72) Inventors: Trong Tao BUI, Hitachinaka-shi, Ibaraki (JP); Koichi YAHATA, Hitachinaka-shi, Ibaraki (JP)

(73) Assignee: HITACHI ASTEMO, LTD., Hitachinaka-shi, Ibaraki (JP)

(21) Appl. No.: 19/108,850

(22) PCT Filed: Oct. 7, 2022
(86) PCT No.: PCT/JP2022/037731

§ 371 Date: Mar. 5, 2025

(51) Int. Cl. H02M 7/5387; H02J 3/0073; H02M 1/00; H02M 1/08; H02M 7/483

(52) U.S. Cl. CPC H02M 7/53871; H02J 3/0073; H02M 1/0006; H02M 1/08; H02M 7/483

(57) ABSTRACT

There is provided a power conversion device including: a switching element connected to upper and lower arms in series; a gate drive circuit configured to drive the switching element; a controller configured to operate with a predetermined low voltage supplied from a low-voltage power supply and output a drive signal for driving the switching element to the gate drive circuit; a gate power supply circuit configured to generate a gate drive voltage for operating the gate drive circuit and supply the generated gate drive voltage to the gate drive circuit; and a backup power supply circuit configured to control a current supplied from a high-voltage power supply to a primary winding of an insulation transformer to generate a backup voltage instead of the low voltage, and supply the generated backup voltage to the controller. The backup power supply circuit is started up with a startup voltage output from the gate power supply circuit.

### DESCRIPTION

### Technical Field

The present invention relates to a power conversion device.

### Background Art

A power conversion device that converts DC power into AC power includes upper and lower arm series circuits for a plurality of phases. The upper and lower arm series circuits are formed by connecting a switching element of an upper arm and a switching element of a lower arm in series. The switching element is driven with a drive signal output from a controller via a gate drive circuit. The controller is normally supplied with power from a low-voltage power supply, but includes a backup power supply circuit to ensure the operation even if the low-voltage power supply is lost. The power of the backup power supply circuit is supplied from a high-voltage power supply different from the low-voltage power supply. In this case, it is necessary to provide a startup circuit stepping down a voltage of the high-voltage power supply to start up the backup power supply circuit.

PTL 1 discloses an inverter control circuit that turns on a specific switching element even when a low-voltage power supply becomes abnormal without adding a dedicated microcomputer. PTL 2 discloses a device that smoothly controls an inverter even when power of a control circuit of the inverter is lost while inhibiting an increase in the size of the device.

### CITATION LIST

### Patent Literature

PTL 1: JP 2017-118815 A
PTL 2: JP 2015-159684 A

### SUMMARY OF INVENTION

### Technical Problem

In the devices disclosed in PTLs 1 and 2, omission of a startup circuit that starts up a backup power supply circuit is not mentioned.

### Solution to Problem

According to an aspect of the present invention, a power conversion device includes: a switching element connected to upper and lower arms in series; a gate drive circuit configured to drive the switching element; a controller configured to operate with a predetermined low voltage supplied from a low-voltage power supply and output a drive signal for driving the switching element to the gate drive circuit; a gate power supply circuit configured to generate a gate drive voltage for operating the gate drive circuit and supply the generated gate drive voltage to the gate drive circuit; and a backup power supply circuit configured to control a current supplied from a high-voltage power supply to a primary winding of an insulation transformer to generate a backup voltage instead of the low voltage, and supply the generated backup voltage to the controller. The backup power supply circuit is started up with a startup voltage output from the gate power supply circuit.

### Advantageous Effects of Invention

According to the present invention, the startup circuit that starts up the backup power supply circuit can be omitted.

### BRIEF DESCRIPTION OF DRAWINGS

FIG. 1 is a diagram illustrating an overall configuration of a power conversion device according to a first embodiment.

FIG. 2 is a diagram illustrating a detailed configuration of main units of the power conversion device according to the first embodiment.

FIGS. 3(A) to 3(F) are timing charts illustrating an operation of a backup power supply circuit according to the first embodiment.

FIG. 4 is a diagram illustrating a wiring pattern of the power conversion device according to the first embodiment.

FIG. 5 is a diagram illustrating a wiring pattern of a power conversion device according to a comparative example.

FIG. 6 is a diagram illustrating an overall configuration of a power conversion device according to a second embodiment.

FIG. 7 is a diagram illustrating a detailed configuration of main units of the power conversion device according to the second embodiment.

FIGS. 8(A) to 8(G) are timing charts illustrating operations of a backup power supply circuit and a gate power supply circuit according to the second embodiment.

Hereinafter, embodiments of the present invention will be described with reference to the drawings. The following description and drawings are examples for describing the present invention, and are omitted and simplified as appropriate to clarify description. The present invention can be implemented in various other forms. Unless otherwise mentioned, the number of constituent elements may be single or plural.

### FIRST EMBODIMENT

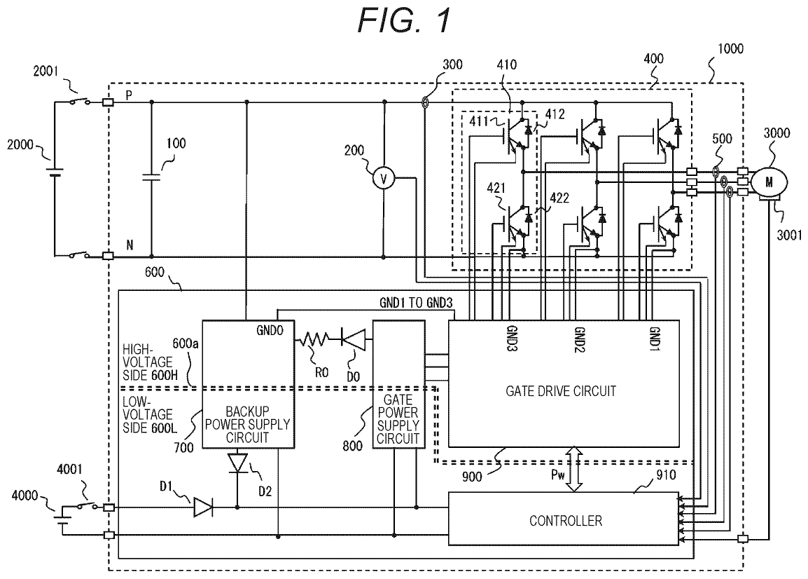

FIG. 1 is a diagram illustrating an overall configuration of a power conversion device 1000 according to a first embodiment.

The power conversion device 1000 converts DC power supplied from a DC high-voltage power supply 2000 such as a battery into AC power and drives a motor 3000. The high-voltage power supply 2000 supplies DC power between a positive electrode bus bar P and a negative electrode bus bar N of the power conversion device 1000 via a contactor 2001. The motor 3000 is, for example, a three-phase induction motor and is used as a drive source of a vehicle. The motor 3000 is provided with an angle sensor 3001 such as a resolver that outputs a rotation angle.

The power conversion device 1000 includes a capacitor module 100 that is connected in parallel between the positive electrode bus bar P and the negative electrode bus bar N and smooths a direct current, a voltage detector 200 that detects a DC voltage between the positive electrode bus bar P and the negative electrode bus bar N, and an inverter circuit 400 that performs power conversion. A DC detector 300 that detects a direct current flowing through the positive electrode bus bar P is included. The power conversion device 1000 further includes an output current detector 500, a backup power supply circuit 700, a gate power supply circuit 800, a gate drive circuit 900, and a controller 910.

The backup power supply circuit 700, the gate power supply circuit 800, the gate drive circuit 900, and the controller 910 are disposed on a substrate 600. The substrate 600 is divided into a high-voltage side 600H and a low-voltage side 600L. The backup power supply circuit 700 and the gate power supply circuit 800 are separated into a high-voltage side 600H and a low-voltage side 600L by an insulating element 600a such as a transformer. The gate drive circuit 900 is disposed on the high-voltage side 600H of the substrate 600, and the controller 910 is disposed on the low-voltage side 600L of the substrate 600.

The inverter circuit 400 includes a power module 410 that configures an upper and lower arm series circuit formed by a switching element 411 and a diode 412 operating as an upper arm and a switching element 421 and a diode 422 operating as a lower arm. The power module 410 is provided for three phases (U-phase, V-phase, and W-phase) corresponding to phase windings of the motor 3000. That is, the inverter circuit 400 includes arms for three phases formed by connecting the switching element 411 of the upper arm and the switching element 421 of the lower arm in series between the positive electrode bus bar P and the negative electrode bus bar N of DC. Here, an example of three phases will be described. For example, the power modules 410 for a plurality of phases may be provided according to the number of phases of the motor 3000.

Emitter sense terminals are provided in the switching element 411 of the upper arm and the switching element 421 of the lower arm, and the emitter sense terminals are connected to the gate drive circuit 900 in order to detect currents flowing through the switching elements 411 and 421.

The emitter of the switching element 421 of the lower arm is connected to a ground GND3 in the gate drive circuit 900. The emitters of the switching elements 421 of the lower arms of the other phases are similarly connected to grounds GND2 and GND1 in the gate drive circuit 900.

A drive signal Pw that is a PWM signal output from the controller 910 is input to base terminals of the switching elements 411 and 421 via the gate drive circuit 900.

The switching elements 411 and 421 are power semiconductor elements made of, for example, an insulated gate bipolar transistor (IGBT), a metal oxide semiconductor field effect transistor (MOSFET), a super junction metal oxide semiconductor field effect transistor (SJ-MOSFET), silicon carbide (SiC), gallium nitride (GaN), or the like.

The output current detector 500 detects an AC current output from a connection point between the switching element of the upper arm and the switching element of the lower arm for each phase, and outputs each detection value to the controller 910.

A DC low-voltage power supply 4000 such as a battery is provided outside of the power conversion device 1000. A contactor 4001 is turned on in accordance with an ignition key of a vehicle, and a low voltage is supplied to the controller 910 from the low-voltage power supply 4000 via a diode D1. Then, the drive signal Pw is output to the gate drive circuit 900 in response to a torque command from a host controller (not illustrated), a detection voltage from the voltage detector 200, a DC detection value from the DC detector 300, an output current detection value from the output current detector 500, and a rotation angle from the angle sensor 3001.

The backup power supply circuit 700 controls a current supplied to the primary winding of the insulation transformer based on power supplied from the high-voltage power supply 2000 via the positive electrode bus bar P, generates a backup voltage instead of a low voltage supplied from the low-voltage power supply 4000, and supplies the backup voltage to the controller 910 and the gate power supply circuit 800 via a diode D2. The backup power supply circuit 700 is started up by supplying a startup voltage (of which details will be described below) output from the gate power supply circuit 800 via a backflow prevention diode D0 and a current limiting resistor R0. The backflow prevention diode D0 and the current limiting resistor R0 prevent the gate power Supply circuit 800 from becoming overloaded and an overvoltage when the voltage of the backup power supply circuit 700 becomes abnormal. Details of the backup power supply circuit 700 will be described below.

The gate power supply circuit 800 generates a gate drive voltage for operating the gate drive circuit 900 based on the low voltage from the low-voltage power supply 4000 or the backup voltage from the backup power supply circuit 700, and supplies the generated gate drive voltage to the gate drive circuit 900. Normally, a voltage lower than that of the low-voltage power supply 4000 is supplied to the gate power supply circuit 800 and the controller 910. However, when the voltage lower than that of the low-voltage power supply 4000 is not supplied due to any kind of failure, a backup voltage instead of the low voltage is supplied from the backup power supply circuit 700.

The gate drive circuit 900 operates using the gate drive voltage supplied from the gate power supply circuit 800, and drives the switching elements 411 and 421 based on the drive signal Pw output from the controller 910. The grounds GND1, GND2, and GND3 in the gate drive circuit 900 are connected to the ground GND0 in the backup power supply circuit 700. Details of the gate drive circuit 900 will be described below.

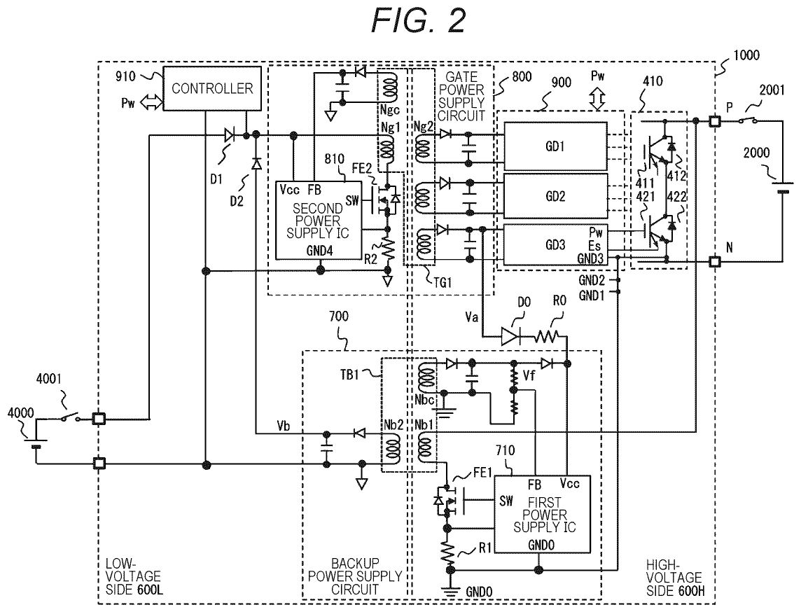

FIG. 2 is a diagram illustrating a detailed configuration of main units of the power conversion device 1000 according to the first embodiment.

In FIG. 2, the power module 410 for one phase is illustrated, and the other phases are not illustrated. The gate power supply circuit 800 and the gate drive circuit 900 corresponding to the switching element 421 of the lower arm are illustrated, and the gate power supply circuit 800 and the gate drive circuit 900 corresponding to the switching element 411 of the upper arm are not illustrated.

The backup power supply circuit 700 includes a first power supply IC 710 and an insulation transformer TB1. Power is supplied to one end of a primary winding Nb1 of the insulation transformer TB1 from the high-voltage power supply 2000 via the positive electrode bus bar P. At the other end of the primary winding Nb1 of the insulation transformer TB1, the field effect transistor FE1 is connected to the ground GND0 via a resistor R1.

The first power supply IC 710 is started up when the startup voltage Va generated by the gate power supply circuit 800 is supplied to a power supply terminal Vcc via the backflow prevention diode D0 and the current limiting resistor R0. Then, switching of the field effect transistor FE1 is controlled with a signal output from the signal terminal SW, and a backup voltage Vb is generated through a flyback operation using a secondary winding Nb2, a diode, and a capacitor of the insulation transformer TB1. The backup voltage Vb is supplied to the controller 910 and the gate power supply circuit 800. The backup voltage Vb is also supplied to the gate power supply circuit 800 corresponding to the switching element 411 of the upper arm (not illustrated).

The insulation transformer TB1 is provided with an auxiliary winding Nbc, and a feedback voltage Vf is generated using an output voltage from the auxiliary winding Nbc. The feedback voltage Vf is supplied to the power supply terminal Vcc of the first power supply IC 710 via the diode, is divided, and is input to a feedback terminal FB of the first power supply IC 710. The first power supply IC 710 performs switching control on the field effect transistor FE1 such that a divided voltage of the feedback voltage Vf input to the feedback terminal FB becomes a predetermined set voltage. Here, since the voltage of the feedback voltage Vf is set to a voltage higher than the startup voltage Va, the operation of the first power supply IC 710 continues using the power from the feedback voltage Vf after the startup of the first power supply IC 710. Accordingly, after the first power supply IC 710 is started up with the startup voltage Va generated by the gate power supply circuit 800, the first power supply IC 710 continues the operation with the feedback voltage Vf.

The gate power supply circuit 800 includes a second power supply IC 810 and an insulation transformer TG1. In the second power supply IC 810, a low voltage from the low-voltage power supply 4000 or the backup voltage Vb from the backup power supply circuit 700 is supplied to the power supply terminal Vcc. One end of the primary winding Ng1 of the insulation transformer TG1 is connected to the power supply terminal Vcc of the second power supply IC 810. At the other end of the primary winding Ng1, the field effect transistor FE2 is connected to the ground GND4 on the low-voltage side via a resistor R2.

The second power supply IC 810 performs switching control on the field effect transistor FE2 by a signal output from the signal terminal SW, and generates a gate drive voltage by flyback operation using the secondary winding Ng2, the diode, and the capacitor of the insulation transformer TG1. Three secondary windings Ng2 of the insulation transformer TG1 are provided to correspond to the three gate drive circuits GD1, GD2, and GD3 that drive the switching element 421 of the lower arm, and each generate a gate drive voltage. Among them, a gate drive voltage supplied to one gate drive circuit GD3 is supplied as the startup voltage Va to the backup power supply circuit 700 via the backflow prevention diode D0 and the current limiting resistor R0. Accordingly, it is not necessary to separately provide a startup circuit that starts up the backup power supply circuit 700. The insulation transformer TG1 is provided with an auxiliary winding Ngc, and a feedback voltage generated using an output voltage from the auxiliary winding Ngc is input to the feedback terminal FB of the second power supply IC 810. The second power supply IC 810 performs switching control on the field effect transistor FE2 such that the feedback voltage input to the feedback terminal FB becomes a predetermined set voltage.

The gate drive circuit 900 indicates three gate drive circuits GD1, GD2, and GD3 that drive the switching element 421 of the lower arm. In the gate drive circuit GD3, the emitter of the switching element 421 is connected to the ground GND3, the base of the switching element 421 is connected to a terminal of the drive signal Pw, and an emitter sense is connected to a terminal Es. The same applies to the gate drive circuits GD1 and GD2. The drive signal Pw output from the controller 910 is input to the base of the switching element 421, and the switching element 421 is turned on and off to be driven. A current flowing through the switching element 421 is transmitted from the emitter sense to the controller 910 via the gate drive circuit GD3, and the controller 910 controls an overcurrent or the like.

The gate drive circuits GD1, GD2, and GD3 drive the switching elements 421 in the lower arms of the respective phases, and the grounds GND1, GND2, and GND3 of the gate drive circuits GD1, GD2, and GD3, that is, the emitters of the switching elements 421 in the lower arms of the respective phases, are connected to the ground GND0 in the backup power supply circuit 700. The reason will be described below.

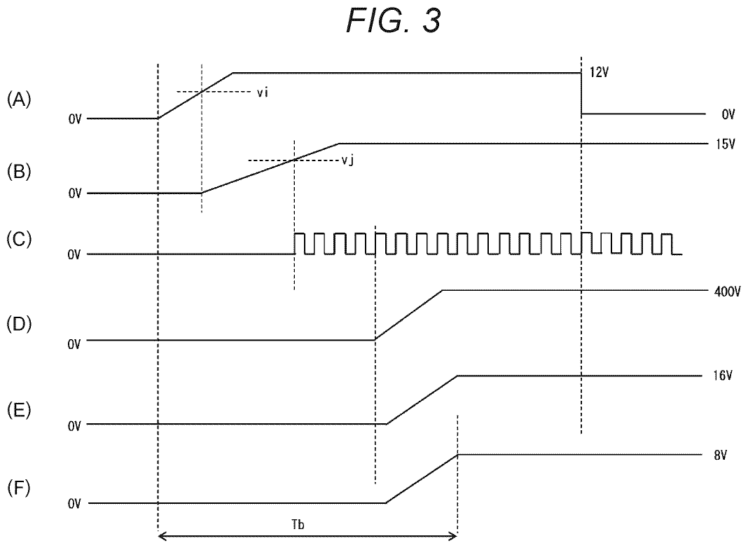

FIGS. 3(A) to 3(F) are timing charts illustrating an operation of the backup power supply circuit 700 according to the first embodiment. FIG. 3(A) illustrates a low voltage supplied from the low-voltage power supply 4000, FIG. 3(B) illustrates a startup voltage Va supplied from the gate drive circuit GD3, FIG. 3(C) illustrates a signal output from the signal terminal SW of the first power supply IC 710, FIG. 3(D) illustrates a high voltage supplied from the high-voltage power supply 2000, FIG. 3(E) illustrates a feedback voltage Vf generated by the backup power supply circuit 700, and FIG. 3(F) illustrates a backup voltage Vb generated by the backup power supply circuit 700.

Hereinafter, a description will be given with reference to the diagram of a detailed configuration of main units of the power conversion device 1000 illustrated in FIG. 2.

When the contactor 4001 is turned on, a low voltage is supplied from the low-voltage power Supply 4000. As illustrated in FIG. 3(A), a voltage input to the controller 910 and the gate power supply circuit 800 gradually rises from 0 V to 12 V. 12 V is an example of the low voltage. Then, when this voltage reaches a startup voltage vi of the second power supply IC 810 of the gate power supply circuit 800, the gate power supply circuit 800 is started up as illustrated in FIG. 3(B).

When the gate power supply circuit 800 is started up and the startup voltage Va becomes higher than an operable voltage vj of the first power supply IC 710 of the backup power supply circuit 700 as illustrated in FIG. 3(B), the first power supply IC 710 starts an operation of the switching control as illustrated in FIG. 3(C). The startup voltage Va of 15 V is an example.

When the contactor 2001 is turned on, the high-voltage power supply 2000 gradually rises to, for example, 400 V as illustrated in FIG. 3(D), and supplies power to the backup power supply circuit 700. Accordingly, as illustrated in FIG. 3(E), a high voltage is applied to the primary winding Nb1 of the insulation transformer TB1 to generate the feedback voltage Vf. The feedback voltage Vf is controlled to a voltage higher than the startup voltage Va, for example, 16 V by switching control of the field effect transistor FE1 performed by the first power supply IC 710. Further, the backup power supply circuit 700 generates the backup voltage Vb as illustrated in FIG. 3(F). The backup voltage Vb is, for example, 8 V. The contactor 4001 is turned on, and the backup power supply circuit 700 enters an operating state after a time Tb. Power is supplied from the high-voltage power supply 2000 to the backup power supply circuit 700. Therefore, the backup voltage Vb is supplied from the backup power supply circuit 700 even when the low voltage is not supplied from the low-voltage power supply 4000 due to any kind of failure.

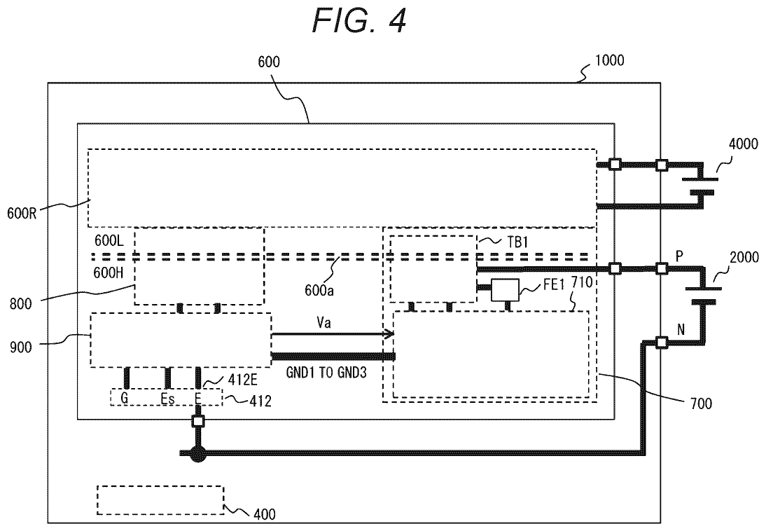

FIG. 4 is a diagram illustrating a wiring pattern of the power conversion device 1000 according to the first embodiment.

The substrate 600 is divided into a high-voltage side 600H and a low-voltage side 600L. The backup power supply circuit 700 and the gate power supply circuit 800 are separated into a high-voltage side 600H and a low-voltage side 600L by an insulating element 600a such as the insulation transformer TB1. The gate drive circuit 900 is disposed on the high-voltage side 600H of the substrate 600, and the controller 910 is disposed in the circuit region 600R on the low-voltage side 600L of the substrate 600. Although the inverter circuit 400 is connected between the positive electrode bus bar P and the negative electrode bus bar N, and the switching elements 411 and 421 in the inverter circuit 400 are connected to the wiring pattern on the substrate 600, a connection state thereof is omitted.

The gate drive circuit 900 supplies the startup voltage Va to the backup power supply circuit 700. The grounds GND1, GND2, and GND3 of the gate drive circuit 900, that is, an emitter 412E of the switching element 421 is connected to the ground GND0 in the backup power supply circuit 700 via the gate drive circuit 900.

The low-voltage power supply 4000 supplies a low voltage to electronic components of the circuit region 600R on the low-voltage side 600L such as the controller 910. The high-voltage power supply 2000 supplies a high voltage to electronic components on the high-voltage side 600H of the power conversion device 1000 via the positive electrode bus bar P and the negative electrode bus bar N. The negative electrode bus bar N is connected to the grounds GND1, GND2, and GND3 based on the emitter 412E of the switching element 421.

That is, in the present embodiment, the ground GND0 of the backup power supply circuit 700 is connected to the emitter-reference grounds GND1, GND2, and GND3 of the gate drive circuit 900, and the emitter-reference grounds GND1, GND2, and GND3 are connected to the negative electrode of the high-voltage power supply 2000 via the negative electrode bus bar N. Accordingly, operations of the gate drive circuit 900 and the backup power supply circuit 700 can be stabilized as compared with a case where the ground GND0 of the backup power supply circuit 700 is directly connected to the negative electrode bus bar N.

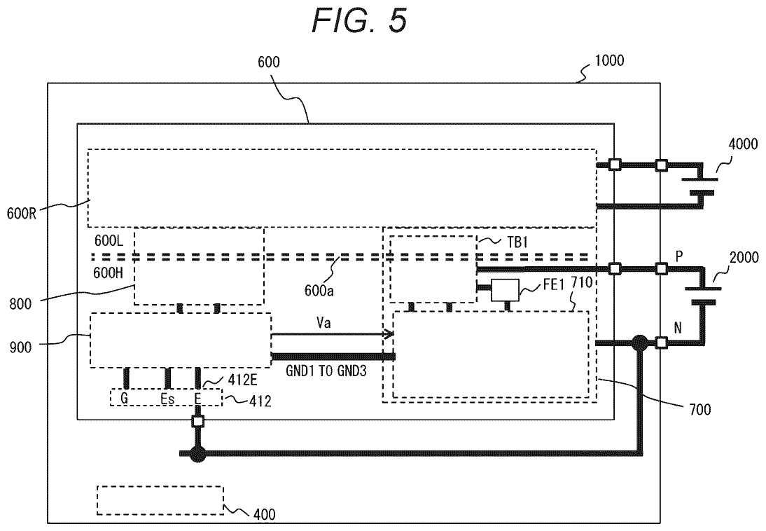

FIG. 5 is a diagram illustrating a wiring pattern of the power conversion device 1000 according to a comparative example. The comparative example illustrated in FIG. 5 is an example to which the first embodiment is not applied, and is an example for comparison with the first embodiment. The same portions as those in FIG. 4 are denoted by the same reference signs, and the description thereof will be simplified.

As illustrated in FIG. 5, in the comparative example, the ground GND0 of the backup power supply circuit 700 is connected to the negative electrode bus bar N. In this case, a loop current is generated between the emitter of the gate drive circuit 900 and the negative electrode bus bar N which is the ground GND0 of the backup power supply circuit 700, and a potential difference occurs between the gate drive circuit 900 and the backup power supply circuit 700. Therefore, the operation of the gate drive circuit 900 becomes unstable. On the other hand, according to the present embodiment illustrated in FIG. 4, the operations of the gate drive circuit 900 and the backup power supply circuit 700 can be stabilized.

According to the first embodiment of the present invention, since the backup power supply circuit 700 is started up by the gate power supply circuit 800 that supplies power to the gate drive circuit 900, a startup circuit separately provided for starting up the backup power supply circuit can be omitted. Accordingly, a component cost is reduced and a mounting area on the substrate is also reduced.

### SECOND EMBODIMENT

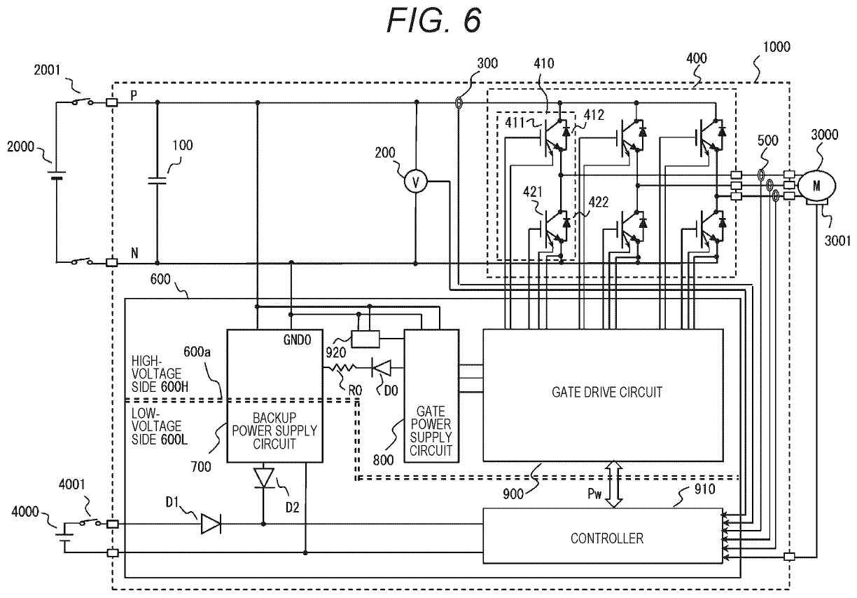

FIG. 6 is a diagram illustrating an overall configuration of the power conversion device 1000 according to a second embodiment. In the first embodiment, the example in which the backup voltage is supplied from the backup power supply circuit to the gate power supply circuit and the controller has been described. In the second embodiment, however, the backup voltage is supplied from the backup power supply circuit to the controller, and a high voltage is supplied to the gate power supply circuit. The same portions as those in FIG. 1 according to the first embodiment are denoted by the same reference signs, and the description thereof will be simplified.

The backup power supply circuit 700, the gate power supply circuit 800, the gate drive circuit 900, the controller 910, and the voltage conversion circuit 920 are disposed on the substrate 600. The substrate 600 is divided into the high-voltage side 600H and the low-voltage side 600L by the insulating element 600a, and the backup power supply circuit 700 is separated into a high-voltage side 600H and a low-voltage side 600L by the insulating element 600a such as a transformer. The gate power supply circuit 800, the gate drive circuit 900, and the voltage conversion circuit 920 are disposed on the high-voltage side 600H, and the controller 910 is disposed on the low-voltage side 600L of the substrate 600.

The backup power supply circuit 700 controls a current supplied to the primary winding of the insulation transformer based on the power supplied from the high-voltage power supply 2000 via the positive electrode bus bar P and the negative electrode bus bar N, generates a backup voltage instead of the low voltage supplied from the low-voltage power supply 4000, and supplies the backup voltage to the controller 910 via the diode D2. The backup power supply circuit 700 is started up by supplying a startup voltage output from the gate power supply circuit 800 via the backflow prevention diode D0 and the current limiting resistor R0. The backflow prevention diode D0 and the current limiting resistor R0 prevent the gate power supply circuit 800 from becoming overloaded and an overvoltage when the voltage of the backup power supply circuit 700 becomes abnormal.

Normally, a low voltage is supplied from the low-voltage power supply 4000 to the controller 910. However, when the low voltage is not supplied from the low-voltage power supply 4000 due to any kind of failure, a backup voltage instead of the low voltage is supplied from the backup power supply circuit 700. Details of the backup power supply circuit 700 will be described below.

The gate power supply circuit 800 generates a gate drive voltage for operating the gate drive circuit 900 based on power supplied from the high-voltage power supply 2000 via the positive electrode bus bar P and the negative electrode bus bar N, and supplies the generated gate drive voltage to the gate drive circuit 900. The gate drive circuit 900 drives the switching elements 411 and 421 based on the drive signal Pw output from the controller 910.

In the first embodiment, the emitter of the switching element 421 of each phase of the lower arm is connected to the ground in the gate drive circuit 900, but is not connected in the present embodiment. In addition, the ground in the gate drive circuit 900 is not connected to the ground in the backup power supply circuit 700.

The voltage conversion circuit 920 steps down the high voltage supplied from the high-voltage power supply 2000 via the positive electrode bus bar P and the negative electrode bus bar N to a predetermined operation voltage for operating the gate power supply circuit 800. After the operation voltage supplied from the voltage conversion circuit 920 exceeds a predetermined value, the gate power supply circuit 800 outputs the startup voltage to the backup power supply circuit 700 via the backflow prevention diode D0 and the current limiting resistor R0 to start up the backup power supply circuit 700.

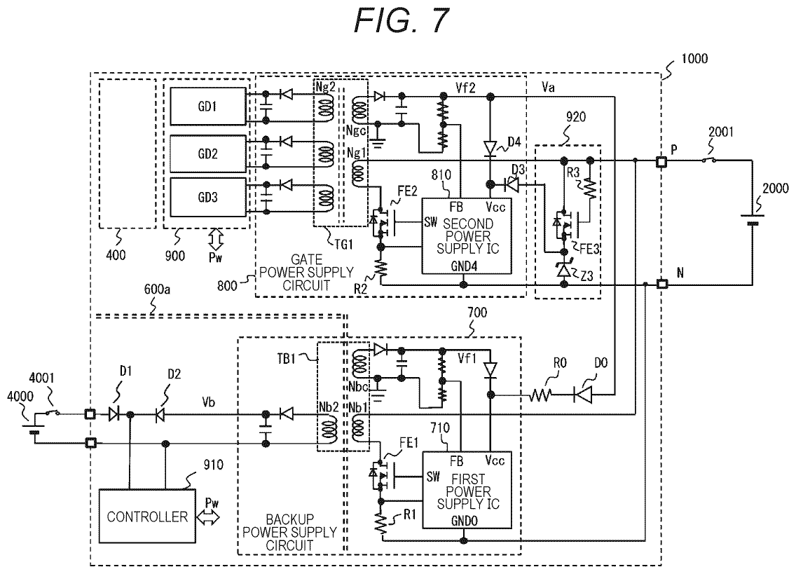

FIG. 7 is a diagram illustrating a detailed configuration of main units of the power conversion device 1000 according to the second embodiment.

In FIG. 7, the gate power supply circuit 800 and the gate drive circuit 900 corresponding to the switching element 421 of the lower arm are illustrated, and the gate power supply circuit 800 and the gate drive circuit 900 corresponding to the switching element 411 of the upper arm are not illustrated. The same portions as those in FIG. 2 of the first embodiment are denoted by the same reference signs, and the description thereof will be simplified.

The backup power supply circuit 700 includes a first power supply IC 710 and an insulation transformer TB1. Power is supplied to one end of a primary winding Nb1 of the insulation transformer TB1 from the high-voltage power supply 2000 via the positive electrode bus bar P. At the other end of the primary winding Nb1 of the insulation transformer TB1, the field effect transistor FE1 is connected to the ground GND0 of the first power supply IC 710 via the resistor R1. The ground GND0 is connected to the negative electrode bus bar N.

The first power supply IC 710 is started up when the startup voltage Va generated by the gate power supply circuit 800 is supplied to a power supply terminal Vcc via the backflow prevention diode D0 and the current limiting resistor R0. Then, switching of the field effect transistor FE1 is controlled with a signal output from the signal terminal SW, and a backup voltage Vb is generated through a flyback operation using a secondary winding Nb2, a diode, and a capacitor of the insulation transformer TB1. The backup voltage Vb is supplied to the controller 910.

The insulation transformer TB1 is provided with the auxiliary winding Nbc, and a feedback voltage Vf1 is generated using the output voltage from the auxiliary winding Nbc. The feedback voltage Vf1 is supplied to the power supply terminal Vcc of the first power supply IC 710 via the diode, is divided into a predetermined voltage, and is input to the feedback terminal FB of the first power supply IC 710. The first power supply IC 710 performs switching control on the field effect transistor FE1 such that a divided voltage of the feedback voltage Vf1 input to the feedback terminal FB becomes a predetermined set voltage. Here, similarly to the first embodiment, since the voltage of the feedback voltage Vf1 is set to a voltage higher than the startup voltage Va, the operation of the first power supply IC 710 continues using the power from the feedback voltage Vf1 after the startup of the first power supply IC 710.

In the voltage conversion circuit 920, a series circuit of a field effect transistor FE3 and a Zener diode Z3 is connected between the positive electrode bus bar P and the negative electrode bus bar N. Then, a voltage from the positive electrode bus bar P is input to the gate of the field effect transistor FE3 via a resistor R3. A connection point between the field effect transistor FE3 and the Zener diode Z3 is input to the power supply terminal Vcc of the second power supply IC 810 via the diode D3. The voltage conversion circuit 920 converts a voltage from the high-voltage power supply 2000 into an operation voltage of the second power supply IC 810 of the gate power supply circuit 800. An output from the connection point between the field effect transistor FE3 and the Zener diode Z3 of the voltage conversion circuit 920 is also supplied to the gate power supply circuit 800 corresponding to the switching element 411 of the upper arm (not illustrated).

The gate power supply circuit 800 includes a second power supply IC 810 and an insulation transformer TG1. The second power supply IC 810 is started up when the operation voltage supplied from the voltage conversion circuit 920 to the power supply terminal Vcc exceeds a predetermined value, performs switching control on the field effect transistor FE2 with a signal output from the signal terminal SW, and generates a gate drive voltage by a flyback operation using the secondary winding Ng2 of the insulation transformer TG1, a diode, and a capacitor. Three secondary windings Ng2 of the insulation transformer TG1 are provided to correspond to the three gate drive circuits GD1, GD2, and GD3 that drive the switching element 421 of the lower arm, and each generate a gate drive voltage.

The insulation transformer TG1 is provided with the auxiliary winding Ngc, and the feedback voltage Vf2 generated using the output voltage from the auxiliary winding Ngc is divided and input to the feedback terminal FB of the second power supply IC 810. The second power supply IC 810 of the gate power supply circuit 800 performs switching control on the field effect transistor FE2 such that the divided voltage of the feedback voltage Vf2 input to the feedback terminal FB becomes a predetermined set voltage after the second power supply IC 810 is started up with the operation voltage supplied from the voltage conversion circuit 920 exceeding a predetermined value. The feedback voltage Vf2 is also input to the power supply terminal Vcc of the second power supply IC 810 via the diode D4. That is, the feedback voltage Vf2 or the operation voltage from the voltage conversion circuit 920 is supplied to the power supply terminal Vcc of the second power supply IC 810.

Here, since the voltage of the feedback voltage Vf2 is set to a voltage higher than the operation voltage from the voltage conversion circuit 920, the operation of the second power supply IC 810 continues using the power from the feedback voltage Vf2 after the startup of the second power supply IC 810. The feedback voltage Vf2 is input as the startup voltage Va to the power supply terminal Vcc of the first power supply IC 710 in the backup power supply circuit 700 via the backflow prevention diode D0 and the current limiting resistor R0, and starts up the backup power supply circuit 700. That is, the gate power supply circuit 800 generates the startup voltage Va and starts up the backup power supply circuit 700 after the operation voltage supplied from the voltage conversion circuit 920 exceeds the predetermined value.

The gate drive circuit 900 indicates three gate drive circuits GD1, GD2, and GD3 that drive the switching element 421 of the lower arm. The drive signal Pw output from the controller 910 is input to the base of the switching element 421, and the switching element 421 is turned on and off to be driven. Three gate drive circuits that drive the switching element 411 of the upper arm (not illustrated) have a similar configuration.

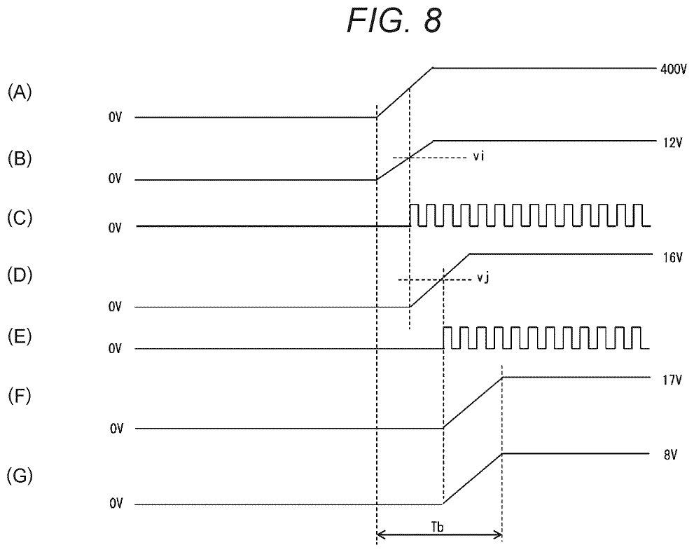

FIGS. 8(A) to 8(G) are timing charts illustrating operations of the backup power supply circuit 700 and the gate power supply circuit 800 according to the second embodiment. FIG. 8(A) illustrates a high voltage supplied from the high-voltage power supply 2000, FIG. 8(B) illustrates an operation voltage of the second power supply IC 810 supplied from the voltage conversion circuit 920, FIG. 8(C) illustrates a signal output from the signal terminal SW of the second power supply IC 810, FIG. 8(D) illustrates the feedback voltage Vf2 generated by the gate power supply circuit 800, FIG. 8(E) illustrates a signal output from the signal terminal SW of the first power supply IC 710, FIG. 8(F) illustrates the feedback voltage Vf1 generated by the backup power supply circuit 700, and FIG. 8(G) illustrates the backup voltage Vb generated by the backup power supply circuit 700.

Hereinafter, a description will be given with reference to the diagram of a detailed configuration of main units of the power conversion device 1000 illustrated in FIG. 7.

When the contactor 4001 is turned on, a low voltage is supplied from the low-voltage power supply 4000, and the controller 910 becomes operable. When the contactor 2001 is turned on, as illustrated in FIG. 8(A), a high voltage is supplied from the high-voltage power supply 2000 to the voltage conversion circuit 920. Accordingly, an output voltage of the voltage conversion circuit 920 gradually rises from 0 V to 12 V. 12 V is an example of the low voltage. Then, when this voltage reaches the startup voltage vi of the second power supply IC 810 of the gate power supply circuit 800, the gate power supply circuit 800 is started up as illustrated in FIG. 8(C).

When the gate power supply circuit 800 is started up and the feedback voltage Vf2 becomes higher than operable voltage vj of the first power supply IC 710 of the backup power supply circuit 700 as illustrated in FIG. 8(D), the first power supply IC 710 starts the switching control operation as illustrated in FIG. 8(E). The feedback voltage Vf2 of 16 V is an example.

When the first power supply IC 710 starts operation and performs switching control on the field effect transistor FE1, the feedback voltage Vf1 is generated as illustrated in FIG. 8(F). At this time, the feedback voltage Vf1 is controlled to a voltage higher than the startup voltage Va of, for example, 17 V. Further, the backup power supply circuit 700 generates the backup voltage Vb as illustrated in FIG. 8(G). The backup voltage Vb is, for example, 8 V. The contactor 2001 is turned on, and the backup power supply circuit 700 enters the operating state after the time Tb. Power is supplied from the high-voltage power supply 2000 to the backup power supply circuit 700. Therefore, the backup voltage Vb is supplied from the backup power supply circuit 700 even when the low voltage is not supplied from the low-voltage power supply 4000 due to any kind of failure.

According to the second embodiment of the present invention, since the gate power supply circuit 800 is started up by the voltage conversion circuit 920 and the backup power supply circuit 700 is started up by the started gate power supply circuit 800, a startup circuit separately provided for starting up the backup power supply circuit can be omitted. Accordingly, a component cost is reduced and a mounting area on the substrate is also reduced.

In the first embodiment described above, when the supply of the low voltage from the low-voltage power supply 4000 is stopped from the beginning due to any kind of failure, the gate power supply circuit 800 cannot be started up, and thus the backup power supply circuit 700 cannot be started up. On the other hand, in the second embodiment, even when the supply of the low voltage from the low-voltage power supply 4000 is stopped from the beginning due to any kind of failure, the high voltage supplied from the high-voltage power supply 2000 is converted by the voltage conversion circuit 920 to generate the operation voltage of the second power supply IC 810, and the gate power supply circuit 800 can be started up using the operation voltage. Then, the backup power supply circuit 700 can be started up using the startup voltage Va (the feedback voltage Vf2) output from the started gate power supply circuit 800. Accordingly, according to the second embodiment, availability of the power conversion device 1000 can be further improved.

According to the embodiment described above, it is possible to obtain the following operational effects.
(1) The power conversion device 1000 includes switching elements 411 and 42 connected to the upper and lower arms in series; a gate drive circuit 900 configured to drive the switching elements 411 and 42; a controller 910 configured to operate with a predetermined low voltage supplied from a low-voltage power supply 4000 and output a drive signal Pw for driving the switching elements 411 and 42 to the gate drive circuit 900; a gate power supply circuit 800 configured to generate a gate drive voltage for operating the gate drive circuit 900 and supply the generated gate drive voltage to the gate drive circuit 900, and a backup power supply circuit 700 configured to control a current supplied from the high-voltage power supply 2000 to the primary winding of an insulation transformer TB1 to generate a backup voltage Vb instead of the low voltage, and supply the generated backup voltage Vb to the controller 910. The backup power supply circuit 700 is started up with a startup voltage Va output from the gate power supply circuit 800. Accordingly, the startup circuit that starts up the backup power supply circuit can be omitted.

The present invention is not limited to the above-described embodiments, and other forms considered within the scope of the technical ideas of the present invention are also included within the scope of the present invention as long as the features of the present invention are not impaired. The above-described embodiments may be combined.

### REFERENCE SIGNS LIST

200 voltage detector
300 DC detector
400 inverter circuit
410 power module
411, 421 switching element
412, 422 diode
500 output current detector
600 substrate
600a insulating element
600H high-voltage side of substrate
600L low-voltage side of substrate
700 backup power supply circuit
710 first power supply IC
800 gate power supply circuit
810 second power supply IC
900, GD1, GD2, GD3 gate drive circuit
910 controller
1000 power conversion device
2000 high-voltage power supply
2001 contactor
3000 motor
4000 low-voltage power supply
4001 contactor
TB1, TG1 insulation transformer
FE1, FE2 field effect transistor
R1, R2 resistor
Vcc power supply terminal
SW signal terminal
FB feedback terminal
Va startup voltage
Vb backup voltage
D0 backflow prevention diode
R0 current limiting resistor
GND1, GND2, GND3 ground
P positive electrode bus bar
N negative electrode bus bar
Pw drive signal

1. A power conversion device comprising:
a switching element connected to upper and lower arms in series;
a gate drive circuit configured to drive the switching element;
a controller configured to operate with a predetermined low voltage supplied from a low-voltage power supply and output a drive signal for driving the switching element to the gate drive circuit;
a gate power supply circuit configured to generate a gate drive voltage for operating the gate drive circuit and supply the generated gate drive voltage to the gate drive circuit; and
a backup power supply circuit configured to control a current supplied from a high-voltage power supply to a primary winding of an insulation transformer to generate a backup voltage instead of the low voltage, and supply the generated backup voltage to the controller,
wherein the backup power supply circuit is started up with a startup voltage output from the gate power supply circuit.

2. The power conversion device according to claim 1, wherein the gate power supply circuit generates the gate drive voltage based on the low voltage and outputs the generated gate drive voltage, as the startup voltage, to the backup power supply circuit.

3. The power conversion device according to claim 2, wherein the backup power supply circuit supplies the backup voltage to the gate power supply circuit and the controller.

4. The power conversion device according to claim 2, wherein the gate power supply circuit generates the gate drive voltage and starts up the backup power supply circuit after the low voltage supplied from the low-voltage power supply exceeds a predetermined value.

5. The power conversion device according to claim 1, wherein a ground of the backup power supply circuit is connected to an emitter-reference ground of the gate drive circuit, and the emitter-reference ground is connected to a negative electrode of the high-voltage power supply via a bus bar.

6. The power conversion device according to claim 1, wherein the gate power supply circuit generates the gate drive voltage and the startup voltage, based on a predetermined high voltage supplied from the high-voltage power supply, and outputs the generated startup voltage to the backup power supply circuit.

7. The power conversion device according to claim 6, further comprising a voltage conversion circuit configured to convert the high voltage supplied from the high-voltage power supply into an operation voltage of the gate power supply circuit,
wherein the gate power supply circuit operates using the operation voltage supplied from the voltage conversion circuit.

8. The power conversion device according to claim 7, wherein the gate power supply circuit generates the startup voltage and starts up the backup power supply circuit after the operation voltage supplied from the voltage conversion circuit exceeds a predetermined value.

9. The power conversion device according to claim 1, wherein the backup power supply circuit includes a power supply IC that controls a current supplied from the high-voltage power supply to the primary winding of the insulation transformer, and the power supply IC is started up by receiving the startup voltage output from the gate power supply circuit.

10. The power conversion device according to claim 9, wherein the startup voltage generated by the gate power supply circuit is supplied to a power supply terminal of the power supply IC via a backflow prevention diode and a current limiting resistor.

11. The power conversion device according to claim 10, wherein
the backup power supply circuit generates a feedback voltage based on the current supplied from the high-voltage power supply to the primary winding of the insulation transformer, and
the feedback voltage generated by the backup power supply circuit is supplied to the power supply terminal after the power supply IC is started up by receiving the startup voltage.
